(19) United States
(12) Patent Application Publication
(10) Pub. No.: US 2018/0096139 A1
(43) Pub. Date: Apr. 5, 2018

(54) METHOD AND SYSTEM FOR DEFENSE AGAINST RETURN ORIENTED PROGRAMMING (ROP) BASED ATTACKS

(71) Applicants: Huawei International Pte. Ltd., Singapore (SG); Singapore Management University, Singapore (SG)

(72) Inventor: Debin GAO, Singapore (SG)

(21) Appl. No.: 15/820,857

(22) Filed: Nov. 22, 2017

Related U.S. Application Data
(63) Continuation of application No. PCT/SG2016/050047, filed on Feb. 1, 2016.

(30) Foreign Application Priority Data
May 25, 2015 (SG) SG10201504066Q

(51) Int. Cl. G06F 21/54; G06F 9/30

(52) U.S. Cl. CPC G06F 21/54; G06F 2221/034; G06F 9/30181

(57) ABSTRACT

Embodiments of the application provide method and system for defense against ROP attacks. The method comprises: identifying a substitutable instruction pair in a binary file, which includes a first instruction for pushing a first group of registers into a stack memory, and a second instruction for popping the first group of registers off the stack memory, generating an equivalent instruction pair for the substitutable instruction pair, which includes a first equivalent instruction for pushing a second group of registers onto the stack memory, and a second equivalent instruction for popping the second group of registers off the stack memory, wherein the second group of registers includes the first group of registers and at least one additional register which is not used by the substitutable instruction pair, and overwriting the first instruction and the second instruction with the first equivalent instruction and the second equivalent instruction respectively.

### CROSS-REFERENCE TO RELATED APPLICATIONS

This application is a continuation of International Application No. PCT/SG2016/050047, filed on Feb. 1, 2016, which claims priority to Singapore Patent Application No. SG10201504066Q, filed on May 25, 2015. The disclosures of the aforementioned applications are hereby incorporated by reference in their entireties.

### TECHNICAL FIELD APPLICATION

The application generally relates to Return Oriented Programming (ROP) mitigation strategy, and more particularly, method and system for defense against ROP-based attacks in a mobile computer system running on Acom/Advanced Reduced Instruction Set Computing (RISC) Machines (ARM) architectures.

### BACKGROUND

ROP is an advanced software exploit technique that allows an attacker to achieve a malicious purpose without code injection. ROP-based attack technique is widely adopted in software and system exploitation, to bypass modern security defense techniques, such as non-executable memory and code signing. The ROP-based attack technique can be applied to a variety of computer systems, such as desktop computer systems operating on X86 platforms and mobile computer systems running on ARM architectures, e.g. Apple iPhone operating system (iOS) and Google Android operating system.

Various mitigation strategies have been proposed to protect X86 platforms from ROP-based attacks, e.g. Address Space Layout Randomization (ASLR) and instruction randomization. However, there is no effective ROP mitigation strategy which can be applied to mobile computer systems running on ARM architectures.

### SUMMARY OF APPLICATION

In order to provide an effective ROP mitigation strategy for defense against ROP-based attacks on a computer system, especially a mobile computer system running on an ARM architecture, embodiments of the application provide a novel instruction randomization technique which performs instruction substitution on instruction pairs with randomized equivalent instruction pairs.

According to one aspect of the application, a method for defense against ROP attacks is provided. The method comprises:

identifying a substitutable instruction pair from a binary file, the substitutable instruction pair including a first instruction for pushing a first group of registers onto a stack memory, and a second instruction for popping the first group of registers off the stack memory, wherein the first group of registers includes at least one general purpose register;

generating an equivalent instruction pair for the substitutable instruction pair, the equivalent instruction pair including a first equivalent instruction for pushing a second group of registers onto the stack memory, and a second equivalent instruction for popping the second group of registers off the stack memory, wherein the second group of registers includes the first group of registers and at least one additional register which is not being used by the substitutable instruction pair; and

overwriting the first instruction and the second instruction with the first equivalent instruction and the second equivalent instruction respectively.

In one embodiment of the application, the equivalent instruction pair is generated by: ascertaining a group of alternative instruction pairs for the substitutable instruction pair based on a group of selectable general purpose registers for the substitutable instruction pair; and selecting a random one from the ascertained group of alternative instruction pairs as the equivalent instruction pair. In another embodiment of the application, the equivalent instruction pair is generated by: selecting the at least one additional register from a group of selectable general purpose registers for the substitutable instruction pair; and generating the equivalent instruction pair based on the selected at least one additional register. In these two embodiments of the application, the group of selectable general purpose registers is determined according to instruction type of the substitutable instruction pair and is not being used by the substitutable instruction pair

In one embodiment of the application, the binary file is comprised in a compressed application file which is to be loaded into a computer system, the method further comprising: unpacking the compressed application file to locate the binary file from the unpacked application file; and after modifying the unpacked application file by overwriting the substitutable instruction pair identified in the binary file with the generated equivalent instruction pair, repacking the modified application file.

In another embodiment of the application, before identifying the substitutable instruction pair from the binary file, the method further comprising: ascertaining a file to be mapped into a memory during a file mapping procedure as the binary file if the file to be mapped into the memory is in binary format; and mapping the binary file into the memory.

According to another aspect of the application, a system for defense against ROP attacks is provided. The system comprises: a processor and a memory communicably coupled with the processor for storing instructions which are executable by the processor to cause the processor to:

identify a substitutable instruction pair from a binary file, the substitutable instruction pair including a first instruction for pushing a first group of registers onto a stack memory, and a second instruction for popping the first group of registers off the stack memory, wherein the first group of registers includes at least one general purpose register,

generate an equivalent instruction pair for the substitutable instruction pair, the equivalent instruction pair including a first equivalent instruction for pushing a second group of registers onto the stack memory, and a second equivalent instruction for popping the second group of registers off the stack memory, wherein the second group of registers includes the first group of registers and at least one additional register which is not being used by the substitutable instruction pair, and

overwrite the first instruction and the second instruction with the first equivalent instruction and the second equivalent instruction respectively.

According to another aspect of the application, a non-transitory computer-readable storage medium is provided which has stored thereon instructions which, if performed by a computer system, would cause the computer system to perform the method for defense against ROP attacks mentioned above.

With the ROP mitigation strategy provided in the embodiments of the application, applications and systems running on ARM architectures can be successfully protected from ROP based attacks. No extra instructions and control flow transfer need to be introduced into the binary file, and therefore the length of the instructions and the size of the relevant binary file would remain unchanged, and it is not required to recover the control flow from elsewhere.

### BRIEF DESCRIPTION OF THE DRAWINGS

The application will be described in detail with reference to the accompanying drawings, in which:

FIG. 1 is a flow chart illustrating a method for defense against ROP-based attacks according to a first embodiment of the application;

FIG. 2A illustrates a part of a binary file from which a substitutable instruction pair is identified according to one example of the first embodiment;

FIG. 2B illustrates the part of the binary file in which the substitutable instruction pair in FIG. 2A is overwritten with an equivalent instruction pair;

FIG. 3A shows a sp-based addressing instruction which is interposed between a substitutable instruction pair according to another example of the first embodiment;

FIG. 3B shows the modified sp-based addressing instruction after the substitutable instruction pair in FIG. 3A is overwritten with an equivalent instruction pair;

FIG. 3C shows the offset value modification in the sp-based addressing instruction in FIG. 3B; and

FIG. 4 is a flow chart illustrating a method for defense against ROP-based attacks according to a second embodiment of the application.

### DETAILED DESCRIPTION OF EMBODIMENTS OF THE APPLICATION

In the following description, numerous specific details are set forth in order to provide a thorough understanding of various illustrative embodiments of the application. It will be understood, however, to one skilled in the art, that embodiments of the application may be practiced without some or all of these specific details. It is understood that the terminology used herein is for the purpose of describing particular embodiments only, and is not intended to limit the scope of the application. In the drawings, like reference numerals refer to same or similar functionalities or features throughout the several views.

Embodiments of the application provide a ROP mitigation strategy for computer systems, particularly mobile computer systems running on ARM architectures. This strategy can significantly reduce the possibility of ROP-based attacks on the computer systems.

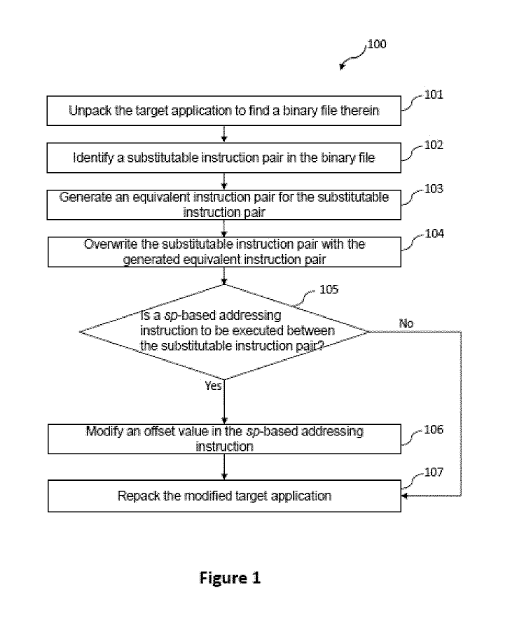

FIG. 1 is a flow chart illustrating a method 100 of defense against ROP-based attacks according to a first embodiment of the application. In this embodiment, the method 100 is applied to rewrite a target application, for execution by a mobile computer system, to prevent an adversary from successfully performing a ROP-based attack on this target application.

In block 101, the target application is unpacked to locate at least one binary file therein.

In one example of the embodiment, the mobile computer system is provided with a Google Android operating system, the target application is an Android application, e.g. an e-book reader named FEReader. In this example, an Android PacKage (APK) tool for unpacking and repacking Android applications is used to unpack the target application. It is to be noted that other tools may be used to unpack the target application in other examples of the embodiment, which depend on the type of the target application.

In block 102, a substitutable instruction pair is identified from the binary file. The substitutable instruction pair includes a PUSH instruction for pushing/storing a first group of registers onto a stack memory and a POP instruction for popping/removing the first group of registers off/from the stack memory.

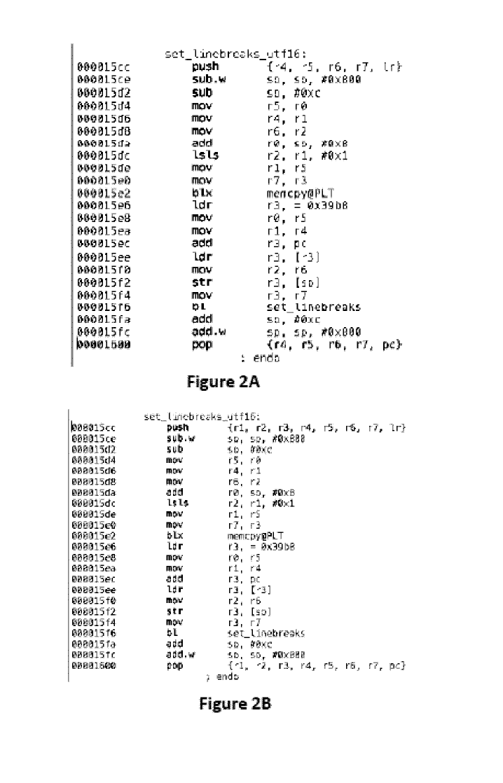

Referring to FIG. 2A which shows a part of a binary file from which a substitutable instruction pair is identified according to one example of the first embodiment. As shown in FIG. 2A, the substitutable instruction pair is identified in a linebreak shared library, where the PUSH instruction is set_linebreaks_utf16:000015cc push {r4, r5, r6, r7, lr}; the POP instruction is 00001600 pop {r4, r5, r6, r7, pc}. In the aforementioned two instructions, r4, r5, r6, r7 are general purpose registers; lr is a link register which is a special purpose for holding the memory address to return to when the PUSH instruction completes; pc is a program counter which is also a special purpose register for holding the memory address of the next instruction that would be executed. According to the aforementioned PUSH instruction and the POP instruction, in this example, the first group of registers includes four general purpose registers r4, r5, r6, r7 which would be pushed and popped by this substitutable instruction pair.

It is to be noted that the number of general purpose registers used by a substitutable instruction pair may be varied and the first group of registers used by the substitutable instruction pair includes at least one general purpose register.

In block 103, an equivalent instruction pair which is to be used to overwrite the substitutable instruction pair is generated. The equivalent instruction pair includes an equivalent PUSH instruction and an equivalent POP instruction. The equivalent PUSH instruction is configured to push/store a second group of registers into the stack memory; the equivalent POP instruction is configured to pop/remove the second group of registers off/from the stack memory. The second group of registers includes the first group of registers and at least one additional register which is not within the first group of registers and selected from a group of selectable general purpose registers.

The group of selectable general purpose registers is determined according to an instruction set type of the substitutable instruction pair. Specifically, the group of selectable general purpose registers includes at least one of the general purpose registers available for the instruction set type of the substitutable instruction pair except the general purpose register r0 and those being used by the substitutable instruction pair. Typically, the group of selectable general purpose registers includes all of the general purpose registers available for the instruction set type of the substitutable instruction pair except the general purpose register r0 and those being used by the substitutable instruction pair. If the instruction set type of the substitutable instruction pair is a THUMB instruction set, there are eight available general purpose registers r0-r7 in total. If the instruction set type of the substitutable instruction pair is an ARM instruction set, there are twelve available general purpose registers r0-r11 in total.

In this embodiment, the equivalent instruction pair may be generated through the following: generate a group of alternative instruction pairs for the substitutable instruction pair according to the group of selectable general purpose registers; then select a random one from the group of alternative instruction pairs as the equivalent instruction pair. It should be noted that the group of alternative instruction pairs includes at least one alternative instruction pair.

Alternatively, the equivalent instruction pair may be generated by the following: select at least one additional register from the group of selectable general purpose registers, then generate an equivalent instruction pair using the selected additional register.

In the example as shown in FIG. 2A, the instruction set type of the substitutable instruction pair is a THUMB instruction set, thus the available general purpose registers include r0-r7. Since r4-r7 have been used by the substitutable instruction pair, the at least one additional register may be selected from r1-r3. Table 1 sets out all of the alternative instruction pairs for the substitutable instruction pair in the example of FIG. 2A.

TABLE 1

| NO. | Alternative Instruction Pairs | |
|---|---|---|
| 1 | push {r1, r4, r5, r6, r7, lr} | pop {r1, r4, r5, r6, r7, pc} |
| 2 | push {r2, r4, r5, r6, r7, lr} | pop {r2, r4, r5, r6, r7, pc} |
| 3 | push {r3, r4, r5, r6, r7, lr} | pop {r3, r4, r5, r6, r7, pc} |
| 4 | push {r1, r2, r4, r5, r6, r7, lr} | pop {r1, r2, r4, r5, r6, r7, pc} |
| 5 | push {r1, r3, r4, r5, r6, r7, lr} | pop {r1, r3, r4, r5, r6, r7, pc} |
| 6 | push {r2, r3, r4, r5, r6, r7, lr} | pop {r2, r3, r4, r5, r6, r7, pc} |
| 7 | push {r1, r2, r3, r4, r5, | pop {r1, r2, r3, r4, r5, |
| | r6, r7, lr} | r6, r7, pc} |
| 8 | push { r4, r5, r6, r7, lr} | pop {r4, r5, r6, r7, pc} |

In block 104, the substitutable instruction pair is overwritten with the generated equivalent instruction pair. The PUSH instruction of the substitutable instruction pair which is configured to for push/store a first group of registers onto a stack memory is overwritten with the equivalent PUSH instruction of the generated equivalent instruction pair which is configured to push/store a second group of registers into the stack memory. The POP instruction of the substitutable instruction pair which is configured to pop/remove the first group of registers off/from the stack memory is overwritten with the equivalent POP instruction of the generated equivalent instruction pair which is configured to pop/remove the second group of registers off/from the stack memory. Referring to FIG. 2B, in this example, the equivalent instruction pair including: push {r1, r2, r3, r4, r5, r6, r7, lr} and pop {r1, r2, r3, r4, r5, r6, r7, pc} is used to overwrite the substitutable instruction pair shown in FIG. 2A, i.e. the PUSH instruction: push {r4, r5, r6, r7, lr} and the POP instruction: pop {r4, r5, r6, r7, pc}.

In block 105, it is ascertained whether a stack pointer based (sp-based) addressing instruction is interposed between the substitutable instruction pair, i.e. between the PUSH instruction and the POP instruction. If a sp-based addressing instruction is interposed between the substitutable instruction pair, then the flow sequence proceeds to block 106; if not, the flow sequence proceeds to block 107.

In block 106, an offset value in the sp-based addressing instruction is modified based on the number of the additional registers used in the substitutable instruction pair and the length of each additional register used in the substitutable instruction pair.

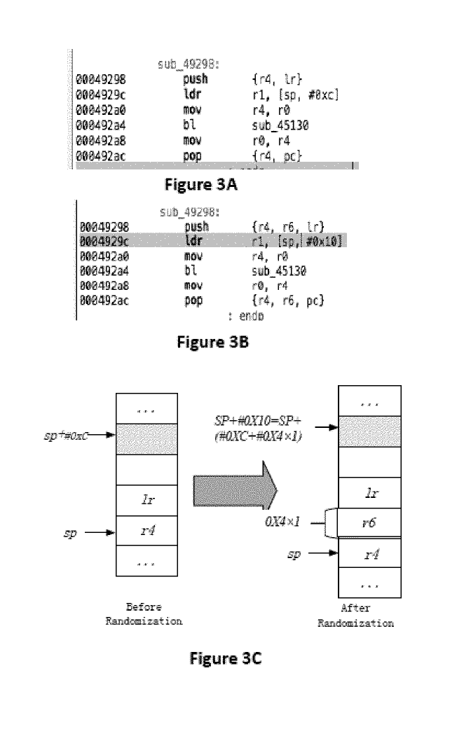

In the step of generating the equivalent instruction pair for the substitutable instruction pair, if n additional registers are used, and each of the additional registers has a length of m bytes, then the offset value in the sp-based addressing instruction is to be modified to: original offset value+m×n. One example of the embodiment is shown in FIGS. 3A-3C. Referring to FIG. 3A, the sp-based addressing instruction “ldr r1, [sp, #0xC]” is interposed between the substitutable instruction pair, i.e. the PUSH instruction push {r4, lr} and the POP instruction pop {r4, pc}. As shown in FIGS. 3B and 3C, only one general purpose register r6 which has a length of 4 bytes is used to generate the equivalent instruction pair to overwrite the substitutable instruction pair. Thus, the offset value in the sp-based addressing instruction is modified to #0x10=#0xC+#0x4×1.

In block 107, the modified target application is repacked.

In the first embodiment, the method for defense against ROP-based attacks introduces an instruction randomization technique through selecting at least one additional register to be pushed and popped. This instruction randomization technique is performed during a loading process of a target application. In other embodiments, this instruction randomization technique may be performed during the execution process of a target application.

According to a second embodiment of the application, the instruction randomization technique is performed during a system's file mapping procedure. In order to realize this, the system's file mapping procedure should be modified to enable the instruction randomization capability.

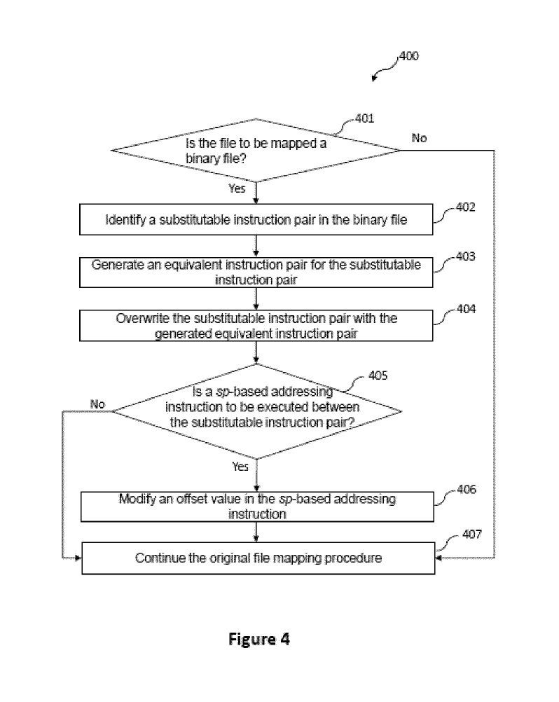

FIG. 4 illustrates a method 400 for defense against ROP-based attacks according to the second embodiment of the application.

In block 401, a file to be mapped into a memory of a computer system is checked to ascertain whether it is a binary file. If the file to be mapped is a binary file, after mapping the binary file into the memory, the flow sequence proceeds to block 402; if the file to be mapped is not a binary file, after mapping the file into the memory, the flow sequence proceeds to block 407, i.e. continue the original file mapping procedure.

In block 402, a substitutable instruction pair is identified in the binary file. The substitutable instruction pair includes a PUSH instruction for pushing/storing a first group of registers onto a stack memory and a POP instruction for popping/removing the first group of registers off/from the stack memory.

This step is similar to the step shown in block 102 in the first embodiment of the application, the difference includes, in the second embodiment, the identification of the substitutable instruction pair is performed on a file image in memory, while in the first embodiment, the identification of the substitutable instruction pair is performed on a file in a file system.

In block 403, an equivalent instruction pair which is to be used to overwrite the substitutable instruction pair is generated.

In block 404, the substitutable instruction pair is overwritten with the equivalent instruction pair.

In block 405, it is ascertained whether a stack pointer based (sp-based) addressing instruction is interposed between the substitutable instruction pair, i.e. the PUSH instruction and the POP instruction, if a sp-based addressing instruction is interposed between the substitutable instruction pair, then the flow sequence proceeds to block 406; if not, the flow sequence proceeds to block 407.

In block 406, an offset value in the sp-based addressing instruction is modified based on the number of the at least one additional register used in the equivalent instruction pair and the length of each additional register used in the equivalent instruction pair.

In the second embodiment, the modification of the offset value is updated to the memory. While in the first embodiment, the modification of offset value is updated to the binary file in the target application.

The technique and strategy in the steps shown in block 403 to block 406 are similar to those shown in block 203 to block 206, and are therefore not described in detail in the second embodiment.

In block 407, the original file mapping procedure is continued.

The above-described methods for defense against ROP-based attacks may be performed by a computer system which comprises a processor and a memory communicably coupled to the processor for storing instructions which are executable by the processor to cause the processor to: identify a substitutable instruction pair in a binary file, the substitutable instruction pair including a first instruction for pushing a first group of general purpose registers onto the stack memory, and a second instruction for popping the first group of general purpose registers off the stack memory, wherein the first group of general purpose registers includes at least one general purpose register; generate an equivalent instruction pair for the substitutable instruction pair, the equivalent instruction pair including a first equivalent instruction for pushing a second group of general purpose registers onto the stack memory, and a second equivalent instruction for popping the second group of general purpose registers off the stack memory, wherein the second group of general purpose registers includes the first group of general purpose registers and at least one additional register which is not used by the substitutable instruction pair; and overwrite the substitutable instruction pair with the generated equivalent instruction pair.

According to one embodiment of the application, when generating the equivalent instruction pair, the processor is further configured to ascertain a group of alternative instruction pairs for the substitutable instruction pair according to a group of selectable general purpose registers for the substitutable instruction pair, and then randomly select one from the ascertained group of alternative instruction pairs as the equivalent instruction pair. According to another embodiment of the application, when generating the equivalent instruction pair, the processor is further configured to select the at least one additional register from a group of selectable general purpose registers for the substitutable instruction pair, and then generate the equivalent instruction pair based on the selected at least one additional register.

In the aforementioned two embodiments, the group of selectable general purpose registers is determined according to instruction type of the substitutable instruction pair and is not being used by the substitutable instruction pair, If the substitutable instruction pair is an ARM instruction pair, the group of selectable general purpose registers includes at least one of r1 to r11 which is not being used by the substitutable instruction pair. If the substitutable instruction pair is a Thumb instruction pair, the selectable general purpose registers include at least one of r1 to r7 which is not being used by the substitutable instruction pair.

According to another embodiment of the application, if the processor ascertains that a sp-based addressing instruction is interposed between the substitutable instruction pair; the processor is further configured to modify an offset value in the sp-based addressing instruction based on the number of the at least one additional register used in the equivalent instruction pair and the length of each additional register.

In one embodiment of the application, the binary file is comprised in a compressed application file which is to be loaded into a computer system, the processor is further configured to:

unpack the compressed application file to locate the binary file from the unpacked application file; and after modifying the unpacked application file by overwriting the substitutable instruction pair identified in the binary file with the generated equivalent instruction pair, repack the modified application file.

In another embodiment of the application, the processor is further configured to: before identifying the substitutable instruction pair from the binary file, ascertain a file to be mapped into a memory during a computer system's file mapping procedure as the binary file if the file to be mapped into the memory is in binary format; and map the binary file into the memory.

The foregoing description is described with reference to mobile computer systems running on ARM architectures. However, it is to be appreciated that embodiments of the application are also suitable to be applied to other platforms/operating systems, e.g. X86 platform, and even in other security directions, e.g. watermarking.

As will be appreciated from the above, embodiments of the application provide an effective method for defense against ROP-based attacks for mobile computer systems running on ARM architectures. The methods disclosed in embodiments of the application can be used by any party who wants to protect a target application and mobile computer system from ROP-based attacks, e.g. application developers, distributors, mobile system developers and application's end-users. For application distributors, such as Google Play, they may perform the method of the application when an application is being downloaded into a user device. For mobile system developers, they may introduce a few lines extra code configured to perform the method during the system's file mapping procedure. For application's end users, they may install a separate application which is to initiate the method of the application during the loading process of the target application.

The embodiments of the application introduce an instruction randomization technique which performs instruction substitution on instruction pairs, e.g. the PUSH instruction and the POP instruction, and overwrites the substitutable instruction pair with a randomized equivalent instruction pair. With this instruction randomization technique, applications and systems running on ARM architectures can be successfully protected from ROP based attacks. Further, this instruction randomization technique introduces neither extra instructions nor extra control flow transfer into the binary files, and therefore the length of the instructions and the size of the binary files would remain unchanged. Additionally, referring to the aforementioned embodiments of the application, the layout of the stack memory and the content of the substitutable instruction pair are to be changed simultaneously, and therefore no further performance cost would be required.

It is to be understood that the embodiments and features described above should be considered exemplary and not restrictive. For example, the above-described embodiments may be used in combination with each other. Many other embodiments will be apparent to those skilled in the art from consideration of the specification and practice of the application. The scope of the application should, therefore, be determined with reference to the appended claims, along with the full scope of equivalents to which such claims are entitled. Furthermore, certain terminology has been used for the purposes of descriptive clarity, and not to limit the disclosed embodiments of the application.

What is claimed is:

1. A method for defense against ROP attacks, the method comprising:
identifying a substitutable instruction pair from a binary file, the substitutable instruction pair including a first instruction for pushing a first group of registers onto a stack memory, and a second instruction for popping the first group of registers off the stack memory, wherein the first group of registers includes at least one general purpose register;
generating an equivalent instruction pair for the substitutable instruction pair, the equivalent instruction pair including a first equivalent instruction for pushing a second group of registers onto the stack memory, and a second equivalent instruction for popping the second group of registers off the stack memory, wherein the second group of registers includes the first group of registers and at least one additional register which is not being used by the substitutable instruction pair; and
overwriting the first instruction and the second instruction with the first equivalent instruction and the second equivalent instruction respectively.

2. The method according to claim 1, wherein the step of generating the equivalent instruction pair further comprises:
ascertaining a group of alternative instruction pairs for the substitutable instruction pair based on a group of selectable general purpose registers for the substitutable instruction pair, wherein the group of selectable general purpose registers is determined according to instruction type of the substitutable instruction pair and is not being used by the substitutable instruction pair; and
selecting a random one from the ascertained group of alternative instruction pairs as the equivalent instruction pair.

3. The method according to claim 1, wherein the step of generating the equivalent instruction pair further comprises:
selecting the at least one additional register from a group of selectable general purpose registers for the substitutable instruction pair, wherein the group of selectable general purpose registers is determined according to instruction type of the substitutable instruction pair and is not being used by the substitutable instruction pair; and
generating the equivalent instruction pair based on the selected at least one additional register.

4. The method according to claim 2, wherein if the substitutable instruction pair is an ARM instruction pair, the group of selectable general purpose registers includes at least one of r1 to r11 which is not being used by the substitutable instruction pair.

5. The method according to claim 2, wherein if the substitutable instruction pair is a Thumb instruction pair, the selectable general purpose registers include at least one of r1 to r7 which is not being used by the substitutable instruction pair.

6. The method according to claim 1, further comprising:
ascertaining whether a stack pointer based (sp-based) addressing instruction is interposed between the substitutable instruction pair;
if a sp-based addressing instruction is interposed between the substitutable instruction pair, modifying an offset value in the sp-based addressing instruction based on a number of the at least one additional register used in the equivalent instruction pair and a length of each additional register.

7. The method according to claim 1, wherein the binary file is comprised in a compressed application file which is to be loaded into a computer system, the method further comprising:
unpacking the compressed application file to locate the binary file from the unpacked application file; and
after modifying the unpacked application file by overwriting the substitutable instruction pair identified in the binary file with the generated equivalent instruction pair, repacking the modified application file.

8. The method according to claim 1, further comprising:
before identifying the substitutable instruction pair from the binary file, ascertaining a file to be mapped into a memory during file mapping procedure as the binary file if the file to be mapped into the memory is in binary format; and
mapping the binary file into the memory.

9. The method according to claim 7, wherein the computer system is a mobile computer system running on an ARM architecture.

10. A system for defense against ROP attacks, comprising:
a processor and a memory communicably coupled with the processor for storing instructions which are executable by the processor to cause the processor to:
identify a substitutable instruction pair from a binary file, the substitutable instruction pair including a first instruction for pushing a first group of registers onto a stack memory, and a second instruction for popping the first group of registers off the stack memory, wherein the first group of registers includes at least one general purpose register,
generate an equivalent instruction pair for the substitutable instruction pair, the equivalent instruction pair including a first equivalent instruction for pushing a second group of registers onto the stack memory, and a second equivalent instruction for popping the second group of registers off the stack memory, wherein the second group of registers includes the first group of registers and at least one additional register which is not being used by the substitutable instruction pair, and
overwrite the first instruction and the second instruction with the first equivalent instruction and the second equivalent instruction respectively.

11. The system according to claim 10, wherein the processor is further configured to
ascertain a group of alternative instruction pairs for the substitutable instruction pair according to a group of selectable general purpose registers for the substitutable instruction pair, wherein the group of selectable general purpose registers is determined according to instruction type of the substitutable instruction pair and is not being used by the substitutable instruction pair, and
randomly select one from the ascertained group of alternative instruction pairs as the equivalent instruction pair.

12. The system according to claim 10, wherein the processor is further configured to
select the at least one additional register from a group of selectable general purpose registers for the substitutable instruction pair, wherein the group of selectable general purpose registers is determined according to instruction type of the substitutable instruction pair and is not being used by the substitutable instruction pair, and
generate the equivalent instruction pair based on the selected at least one additional register.

13. The system according to claim 11, wherein if the substitutable instruction pair is an ARM instruction pair, the group of selectable general purpose registers includes at least one of r1 to r11 which is not being used by the substitutable instruction pair.

14. The system according to claim 11, wherein if the substitutable instruction pair is a Thumb instruction pair, the selectable general purpose registers include at least one of r1 to r7 which is not being used by the substitutable instruction pair.

15. The system according to claim 10, wherein the processor is further configured to:
ascertain whether there is a stack pointer based (sp-based) addressing instruction is interposed between the substitutable instruction pair;
if there is a sp-based addressing instruction is interposed between the substitutable instruction pair, modify an offset value in the sp-based addressing instruction based on a number of the at least one additional register used in the equivalent instruction pair and a length of each additional register.

16. The system according to claim 10, wherein the binary file is comprised in a compressed application file which is to be loaded into a computer system, the processor is further configured to:
unpack the compressed application file to locate the binary file from the unpacked application file; and
after modifying the unpacked application file by overwriting the substitutable instruction pair identified in the binary file with the generated equivalent instruction pair, repack the modified application file.

17. The system according to claim 10, wherein the processor is further configured to:
before identifying the substitutable instruction pair from the binary file, ascertain a file to be mapped into a memory during a file mapping procedure as the binary file if the file to be mapped into the memory is in binary format; and map the binary file into the memory.

18. The system according to claim 16, wherein the computer system is a mobile computer system running on an ARM architecture.

19. A non-transitory computer-readable storage medium having stored thereon instructions which, if performed by a computer system, cause the computer system to perform a method according to claim 1.
